(19) United States
(12) Patent Application Publication
(10) Pub. No.: US 2025/0379707 A1
(43) Pub. Date: Dec. 11, 2025

(54) DEVICES AND METHODS FOR EFFICIENT COMMUNICATION IN A CELLULAR COMMUNICATION NETWORK

(71) Applicant: HUAWEI TECHNOLOGIES CO., LTD., Shenzhen (CN)

(72) Inventors: Alberto Rech, Padova (IT); Stefano Tomasin, Padova (IT); Jonathan Gambini, Milan (IT)

(73) Assignee: HUAWEI TECHNOLOGIES CO., LTD., Shenzhen (CN)

(21) Appl. No.: 19/285,523

(22) Filed: Jul. 30, 2025

Related U.S. Application Data
(63) Continuation of application No. PCT/EP2023/052220, filed on Jan. 31, 2023.

(51) Int. Cl. H04L 5/00

(52) U.S. Cl. CPC H04L 5/0057

(57) ABSTRACT

A user equipment, (UE) for communication with a base station, where the UE includes a communication interface and a processing circuitry. The communication interface receives one or more pilot signals from the base station, and the processing circuitry estimates one or more current channel state information (CSI) values based on the one or more pilot signals from the base station. The processing circuitry quantizes the one or more current CSI values for obtaining one or more current quantized CSI values, and encodes the one or more current quantized CSI values based on a cell-specific encoding scheme for obtaining one or more current encoded quantized CSI values. The cell-specific encoding scheme defines a mapping from a plurality of possible quantized CSI values to a plurality of bit sequences with different numbers of bits.

Attachment: Abstract as amended herein (clean copy on separate sheet)

### CROSS-REFERENCE TO RELATED APPLICATIONS

This application is a continuation of International Application No. PCT/EP2023/052220, filed on Jan. 31, 2023, the disclosure of which is hereby incorporated by reference in its entirety.

### FIELD

The present disclosure relates to communications in a cellular communication network. Embodiments of the present disclosure include devices and methods for efficient communication in a cellular communication network, in particular a 5G cellular communication network for channel state information (CSI) feedback.

### BACKGROUND

In a cellular communication network, the channel state information (CSI) of the channel between a new generation base station node (gNB), i.e. a base station, and a user equipment (UE) may be important for a proper resource allocation. The base station may in particular need to know the CSI of the downlink channel, which is for example not immediately available when operating in frequency division duplexing (FDD) mode, wherein the uplink and downlink channels use different frequency bands. Moreover, when operating at high frequencies, e.g., millimeter waves, and the gNB is equipped with multiple antennas, the CSI may have to be obtained for different beams probed by the gNB, i.e., for different spatial (angular) directions of downlink transmissions. To this end, the 3GPP standard provides solutions for an initial rough estimate of the CSI of the downlink channel and its subsequent refinement. According to the Third Generation Partnership Project (3GPP) standard, the gNB may send known pilot signals to the UE, i.e., channel state information reference signals (CSI-RSs), and the UE in turn estimates the CSI and then feeds back to the gNB a quantized version of the CSI to be used by the gNB to communicate optimally over the downlink channel.

### SUMMARY

Embodiments of the present disclosure provide devices and methods for a more efficient communication in a cellular communication network for CSI feedback.

According to a first aspect a user equipment (UE) is provided for communication with a base station within a coverage region, i.e., a cell of the base station of a cellular communication network, for instance a 5G communication network. The UE comprises a communication interface configured to receive one or more pilot signals from the base station and a processing circuitry configured to estimate one or more current channel state information (CSI) values based on the one or more pilot signals from the base station. The processing circuitry is further configured to quantize the one or more current CSI values for obtaining one or more current quantized CSI values and encode the one or more current quantized CSI values based on a cell-specific encoding scheme for obtaining one or more current encoded quantized CSI values. The cell-specific encoding scheme defines a mapping from a plurality of possible quantized CSI values to a plurality of bit sequences with different numbers of bits which allows for a reduction of the number of bits required to represent the CSI and, thereby, a reduction of the communication overhead.

In a further possible implementation form of the first aspect, the communication interface is further configured to transmit the one or more current encoded quantized CSI values to the base station.

In a further possible implementation form of the first aspect, the mapping defined by the cell-specific encoding scheme is configured to map the plurality of possible quantized CSI values to the plurality of bit sequences with different numbers of bits depending on a respective occurrence frequency of each of the plurality of possible quantized CSI values.

In a further possible implementation form of the first aspect, the mapping defined by the cell-specific encoding scheme is configured to map the most frequent possible quantized CSI values of the plurality of possible quantized CSI values to the bit sequences of the plurality of bit sequences having the smallest numbers of bits.

In a further possible implementation form of the first aspect, the cell-specific encoding scheme is defined by one or more coding codebooks.

In a further possible implementation form of the first aspect, the communication interface is configured to receive from the base station the one or more coding codebooks and/or information allowing the processing circuitry of the UE to generate or retrieve the one or more coding codebooks.

In a further possible implementation form of the first aspect, the communication interface is further configured to receive one or more quantization codebooks from the base station and/or information allowing the processing circuitry of the UE to generate or retrieve the one or more quantization codebooks. The processing circuitry may be configured to quantize the one or more current CSI values for obtaining the one or more current quantized CSI values based on the one or more quantization codebooks.

In a further possible implementation form of the first aspect, the one or more current CSI values comprise a plurality of current signal to interference plus noise ratio (SINR) values and the one or more quantization codebooks comprise a first quantization codebook for quantizing a peak value of the plurality of current SINR values and a second quantization codebook for quantizing one or more differential values of the plurality of current SINR values relative to the peak value.

In a further possible implementation form of the first aspect, the one or more current CSI values comprise a plurality of current CSI values and the processing circuitry is configured to quantize the plurality of current CSI values using a vector quantization scheme for obtaining the one or more current quantized CSI values.

According to a second aspect a method for operating a user equipment (UE) for communication with a base station is provided. The method comprises:
receiving one or more pilot signals from the base station;
estimating one or more current channel state information (CSI) values based on the one or more pilot signals from the base station;
quantizing the one or more current CSI values for obtaining one or more current quantized CSI values; and
encoding the one or more current quantized CSI values based on a cell-specific encoding scheme for obtaining one or more current encoded quantized CSI values, wherein the cell-specific encoding scheme defines a mapping from a plurality of possible quantized CSI values to a plurality of bit sequences with different numbers of bits which allows for a reduction of the number of bits required to represent the CSI and, thereby, a reduction of the communication overhead.

The method according to the second aspect of the present disclosure can be performed by the UE according to the first aspect of the present disclosure. Thus, further features of the method according to the second aspect of the present disclosure result directly from the functionality of the UE according to the first aspect of the present disclosure as well as its different implementation forms described above and below.

According to a third aspect a base station for communication with at least one user equipment (UE) within a coverage region, i.e., cell of the base station, is provided. The base station comprises a communication interface configured to transmit one or more pilot signals to the at least one UE and to receive from the at least one UE one or more current encoded quantized channel state information (CSI) values based on the one or more pilot signals. The base station further comprises a processing circuitry configured to decode the one or more current encoded quantized CSI values based on a cell-specific decoding scheme. The cell-specific decoding scheme defines a mapping from a plurality of bit sequences with different numbers of bits to a plurality of possible quantized CSI values.

In a further possible implementation form of the third aspect, the mapping defined by the cell-specific decoding scheme is configured to map the plurality of bit sequences with different numbers of bits to a plurality of possible quantized CSI values depending on a respective occurrence frequency of each of the plurality of possible quantized CSI values.

In a further possible implementation form of the third aspect, the mapping defined by the cell-specific decoding scheme is configured to map the bit sequences of the plurality of bit sequences having the smallest numbers of bits to the most frequent possible quantized CSI values of the plurality of possible quantized CSI values.

In a further possible implementation form of the third aspect, the cell-specific decoding scheme is defined by one or more coding codebooks.

In a further possible implementation form of the third aspect, the communication interface is configured to transmit to the at least one UE the one or more coding codebooks and/or information allowing a processing circuitry of the at least one UE to generate or retrieve the one or more coding codebooks.

In a further possible implementation form of the third aspect, in a training stage the communication interface of the base station is further configured to transmit one or more training pilot signals to the at least one UE and to receive from the at least one UE one or more quantized training CSI values and the processing circuitry of the base station is configured to determine the one or more coding codebooks based on the one or more quantized training CSI values.

In a further possible implementation form of the third aspect, the communication interface is further configured to transmit to the at least one UE one or more quantization codebooks and/or information allowing a processing circuitry of the at least one UE to generate or retrieve the one or more quantization codebooks. The one or more quantization codebooks may allow the processing circuitry of the at least one UE to generate the one or more current encoded quantized CSI values.

In a further possible implementation form of the third aspect, the one or more quantization codebooks define a vector quantization.

According to a fourth aspect a method of operating a base station for communication with at least one user equipment (UE) is provided. The method comprises:
transmitting one or more pilot signals to the at least one UE;
receiving from the at least one UE one or more current encoded quantized channel state information (CSI) values based on the one or more pilot signals; and
decoding the one or more current encoded quantized CSI values based on a cell-specific decoding scheme, wherein the cell-specific decoding scheme defines a mapping from a plurality of bit sequences with different numbers of bits to a plurality of possible quantized CSI values.

The method according to the fourth aspect of the present disclosure can be performed by the base station according to the third aspect of the present disclosure. Thus, further features of the method according to the fourth aspect of the present disclosure result directly from the functionality of the base station according to the third aspect of the present disclosure as well as its different implementation forms described above and below.

According to a fifth aspect a computer program product is provided, comprising a non-transitory computer-readable storage medium for storing a program code which causes a computer or a processor to perform the method according to the second aspect or the method according to the fourth aspect, when the program code is executed by the computer or the processor.

Details of one or more embodiments are set forth in the accompanying drawings and the description below. Other features, objects, and advantages will be apparent from the description, drawings, and claims.

### BRIEF DESCRIPTION OF THE DRAWINGS

In the following, embodiments of the present disclosure are described in more detail with reference to the attached figures and drawings, in which:

FIG. 1 shows a base station according to an embodiment of the present disclosure for communicating with one or more user equipment (UE) in a communication cell;

FIG. 2 shows different operation stages of a communication cell comprising a UE according to an embodiment of the present disclosure and a base station;

FIG. 3 is a schematic signaling diagram illustrating an additional control signaling phase for cell-specific quantization and mapping between a UE and a base station according to an embodiment of the present disclosure;

FIGS. 4a-b are schematic diagrams illustrating codebooks implemented by a UE and a base station according to an embodiment of the present disclosure for a Huffman coding;

FIG. 4c is a schematic diagram illustrating a codebook implemented by a UE and a base station according to an embodiment of the present disclosure for a joint Huffman coding;

FIGS. 5a-b are schematic diagrams illustrating codebooks implemented by a UE and a base station according to an embodiment of the present disclosure for a cell-specific quantization and a Huffman coding;

FIG. 5c is a schematic diagram illustrating a codebook implemented by a UE and a base station according to an embodiment of the present disclosure for a joint quantization and a Huffman coding;

FIG. 6 shows a flow diagram illustrating a method for operating a UE with a base station according to an embodiment of the present disclosure; and

FIG. 7 shows a flow diagram illustrating a method of operating a base station for communication with at least one UE according to an embodiment of the present disclosure.

In the following, identical reference signs refer to identical or at least functionally equivalent features.

### DETAILED DESCRIPTION

In the following description, reference is made to the accompanying figures, which form part of the disclosure, and which show, by way of illustration, specific aspects of embodiments of the present disclosure or specific aspects in which embodiments of the present disclosure may be used. It is understood that embodiments of the present disclosure may be used in other aspects and comprise structural or logical changes not depicted in the figures. The following detailed description, therefore, is not to be taken in a limiting sense, and the scope of the present disclosure is defined by the appended claims.

For instance, it is to be understood that a disclosure in connection with a described method may also hold true for a corresponding device or system configured to perform the method and vice versa. For example, if one or a plurality of specific method steps are described, a corresponding device may include one or a plurality of units, e.g., functional units, to perform the described one or plurality of method steps (e.g., one unit performing the one or plurality of steps, or a plurality of units each performing one or more of the plurality of steps), even if such one or more units are not explicitly described or illustrated in the figures. On the other hand, for example, if a specific apparatus is described based on one or a plurality of units, e.g., functional units, a corresponding method may include one step to perform the functionality of the one or plurality of units (e.g., one step performing the functionality of the one or plurality of units, or a plurality of steps each performing the functionality of one or more of the plurality of units), even if such one or plurality of steps are not explicitly described or illustrated in the figures. Further, it is understood that the features of the various exemplary embodiments and/or aspects described herein may be combined with each other, unless specifically noted otherwise.

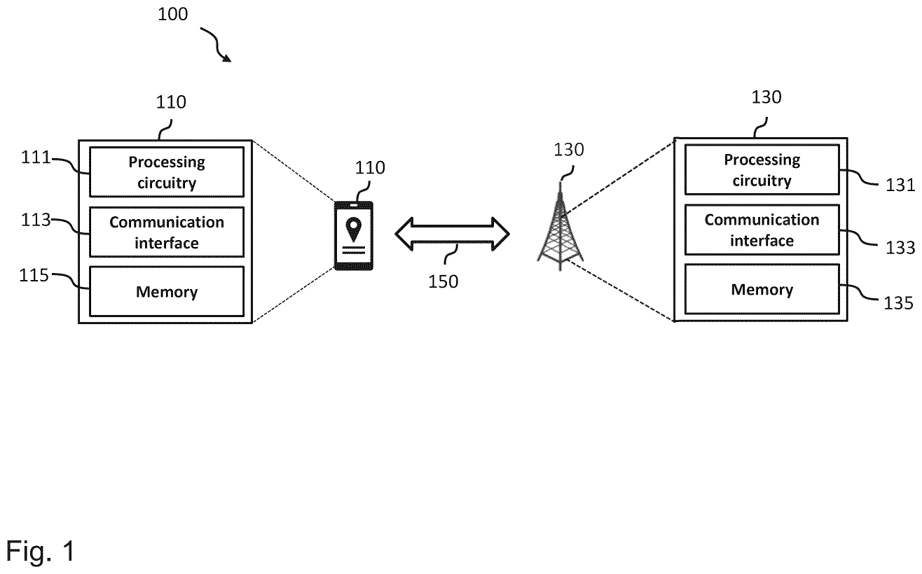

FIG. 1 shows a base station 130 for communicating with one or more user equipment (UE) 110 according to an embodiment of the present disclosure in a communication cell 100 of a cellular communication network, for instance a 5G cellular communication network. The communication cell 100 may be one of a plurality of communication cells of the cellular communication network. As illustrated in FIG. 1, the UE 110 may be within a coverage region 150, i.e., cell of the base station 130, which may be implemented as a gNB 130. The UE 110 may be any device, for example a smartphone, capable for communication with the base station 130. As illustrated in FIG. 1, the UE 110 comprises a processing circuitry 111, and a communication interface 113. The processing circuitry 111 may be implemented in hardware and/or software and may comprise digital circuitry, or both analog and digital circuitry. Digital circuitry may comprise components such as application-specific integrated circuits (ASICs), field-programmable gate arrays (FPGAs), digital signal processors (DSPs), or general-purpose processors. A memory 115 of the UE 110 may be configured to store executable program code which, when executed by the processing circuitry 111, causes the UE 110 to perform the functions and methods described herein.

Likewise, the base station 130 comprises a processing circuitry 131, and a communication interface 133. The processing circuitry 131 may be implemented in hardware and/or software and may comprise digital circuitry, or both analog and digital circuitry. Digital circuitry may comprise components such as application-specific integrated circuits (ASICs), field-programmable gate arrays (FPGAs), digital signal processors (DSPs), or general-purpose processors. A memory 135 of the base station 130 may be configured to store executable program code which, when executed by the processing circuitry 131, causes the base station 130 to perform the functions and methods described herein.

The communication interface 133 of the base station 130 is configured to transmit one or more pilot signals to the at least one UE 110. In an embodiment of the present disclosure, the communication interface 113 of the UE 110 is configured to receive the one or more pilot signals from the base station 130.

As will be described in more detail further below, the processing circuitry 111 of the UE 110 is configured to estimate one or more current channel state information (CSI) values based on the one or more pilot signals from the base station 130. The processing circuitry 111 of the UE 110 is further configured to quantize the one or more current CSI values for obtaining one or more current quantized CSI values and to encode the one or more current quantized CSI values based on a cell-specific encoding scheme for obtaining one or more current encoded quantized CSI values. The cell-specific encoding scheme defines a mapping from a plurality of possible quantized CSI values to a plurality of bit sequences with different numbers of bits.

The communication interface 113 of the UE 110 may be further configured to transmit the one or more current encoded quantized CSI values to the base station 130. The communication interface 133 of the base station 130 is configured to receive from the at least one UE 110 the one or more current encoded quantized CSI values based on the one or more pilot signals.

The processing circuitry 131 of the base station 130 is configured to decode the one or more current encoded quantized CSI values based on a cell-specific decoding scheme. Complementary to the cell-specific encoding scheme, the cell-specific decoding scheme defines a mapping from a plurality of bit sequences with different numbers of bits to a plurality of possible quantized CSI values.

The mapping defined by the cell-specific encoding scheme may be configured to map the plurality of possible quantized CSI values to the plurality of bit sequences with different numbers of bits depending on a respective occurrence frequency of each of the plurality of possible quantized CSI values. In an embodiment of the present disclosure, the mapping defined by the cell-specific decoding scheme may be configured to map the plurality of bit sequences with different numbers of bits to a plurality of possible quantized CSI values depending on a respective occurrence frequency of each of the plurality of possible quantized CSI values.

The mapping defined by the cell-specific encoding scheme may be configured to map the most frequent possible quantized CSI values of the plurality of possible quantized CSI values to the bit sequences of the plurality of bit sequences having the smallest numbers of bits. In an embodiment of the present disclosure, the mapping defined by the cell-specific decoding scheme may be configured to map the bit sequences of the plurality of bit sequences having the smallest numbers of bits to the most frequent possible quantized CSI values of the plurality of possible quantized CSI values.

As will be described in more detail below, the cell-specific encoding scheme may be defined by one or more coding codebooks. In an embodiment of the present disclosure, the cell-specific decoding scheme may be defined by one or more coding codebooks.

The communication interface 133 of the base station 130 may be configured to transmit to the at least one UE 110 the one or more coding codebooks and/or information allowing the processing circuitry 111 of the at least one UE 110 to generate or retrieve the one or more coding codebooks. In an embodiment of the present disclosure, the communication interface 113 of the UE 110 may be configured to receive from the base station 130 the one or more coding codebooks and/or information allowing the processing circuitry 111 of the UE 110 to generate or retrieve the one or more coding codebooks.

As will be described in more detail below, the communication interface 133 of the base station 130 may be further configured to transmit to the at least one UE 110 one or more quantization codebooks and/or information allowing the processing circuitry 111 of the at least one UE 110 to generate or retrieve the one or more quantization codebooks. The one or more quantization codebooks may allow the processing circuitry 111 of the at least one UE 110 to generate the one or more current encoded quantized CSI values. The one or more quantization codebooks may define a vector quantization.

In an embodiment of the present disclosure, the communication interface 113 of the UE 110 may be configured to receive the one or more quantization codebooks from the base station 130 and/or information allowing the processing circuitry 111 of the UE 110 to generate or retrieve the one or more quantization codebooks. The processing circuitry 111 of the UE 110 may be configured to quantize the one or more current CSI values for obtaining the one or more current quantized CSI values based on the one or more quantization codebooks.

The one or more current CSI values may comprise a plurality of current signal to interference plus noise ratio (SINR) values and the one or more quantization codebooks may comprise a first quantization codebook for quantizing a peak value of the plurality of current SINR values and a second quantization codebook for quantizing one or more differential values of the plurality of current SINR values relative to the peak value. In an embodiment of the present disclosure, the one or more current CSI values may comprise a plurality of current CSI values and the processing circuitry 111 of the UE 110 may be configured to quantize the plurality of current CSI values using a vector quantization scheme for obtaining the one or more current quantized CSI values.

According to an embodiment of the present disclosure, the UE 110 and the base station 130 may be configured for an adaptive mapping and joint quantization for CSI information refinement. This may comprise one or more of the following steps, which are described in more detail further below. In the following, it is referred to a SINR-based approach for the sake of clarity, however, as will be appreciated, the UE 110 and the base station 130 may be also configured for a precoder-based approach or an approach based on any other quantity that is relevant for determining or characterizing the channel state information, where each SINR value is replaced by a precoder or by the any other quantity.

A first step may comprise the transmission from the base station 130 of one or more quantization codebooks for the joint quantization of several SINRs. The quantization codebooks, i.e. dictionaries, may be sent to any UE 110 that enters the communication cell 100 for the first time.

A second step may comprise the transmission from the base station 130 of mapping functions to be used on the quantized values by the at least one UE 110. These mapping functions may be represented for example by the coding codebook, which may be for example a dictionary of quantization indices and bit sequences to be transmitted and may be sent to any UE 110 that enters the communication cell 100 for the first time. The bit sequences of the mapping functions, in particular the coding codebook, may have a variable length, based on the propagation condition of the communication cell 100. Since in each communication cell 100 different channels occur with different probabilities, for example according to the positions of scatterers in the communication cell 100, shorter bit sequences may be used for more common quantized codewords, and longer bit sequences may be used for less frequent quantized codewords. Thus, a cell-specific mapping may be obtained. The second step may also be implemented using traditional quantizers, as described further below.

A third step may comprise a joint quantization by the UE 110 of SINRs values related to multiple CSI-RSs, according to the quantization codebook obtained in the first step. Here, the vector of SINRs may be quantized using the quantization codebook of the first step. The quantization may be performed on the entire set of SINRs, i.e. it may be a joint quantization.

A fourth step may comprise the mapping of the quantized values by the UE 110 into a bit sequence according to the mapping functions, in particular the coding codebook, of the second step. This mapping may also be performed when quantization is performed according to traditional methods, i.e. not using the joint quantization of the third step.

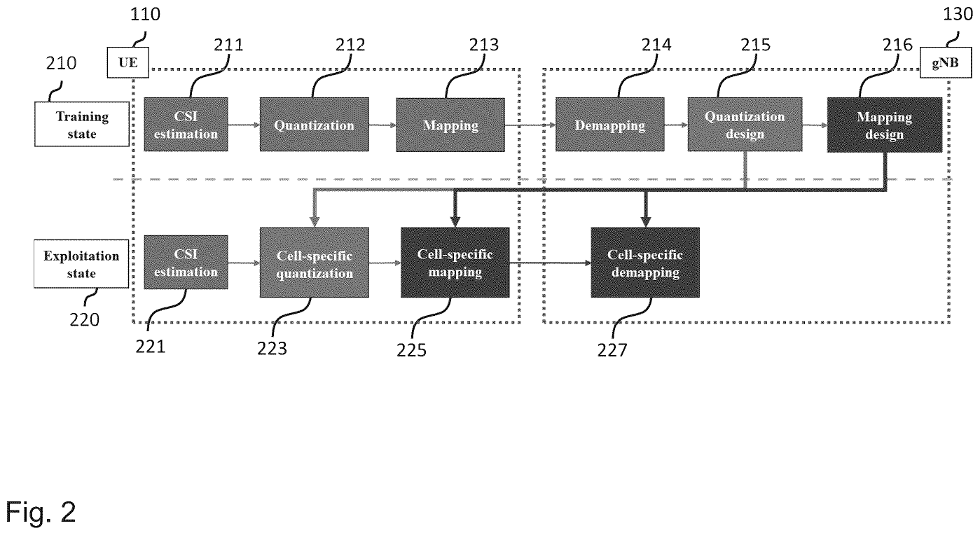

FIG. 2 shows different operation stages of the communication cell 100 comprising the UE 110 and the base station 130 according to an embodiment of the present disclosure. The operation stages of the communication cell 100 may comprise, corresponding to two temporally distinct phases, a training stage 210 (also referred to as training state in FIG. 2) and an exploitation stage 220 (also referred to as exploitation state in FIG. 2).

Generally, in the training stage 210 the communication cell 100 may be configured for the design of quantization and mapping parameters, e.g., codebook and dictionaries, in particular the one or more quantization codebooks and the one or more coding codebooks.

Generally, in the exploitation stage 220 the communication cell 100 may be configured for the use of the obtained quantization and mapping parameters, e.g., codebook and dictionaries, in particular the one or more quantization codebooks and the one or more coding codebooks.

More specifically, in the training stage 210 the base station 130 may transmit CSI-RS signals to the UE 110.

Based on this, as illustrated by step 211 of FIG. 2, the UE 110 may perform the CSI estimation in terms of (but not limited to) SINR measurements, for example according to one option of the 3GPP standard.

In steps 212 and 213 of FIG. 2, the UE 110 may then quantize and map the SINR measurements according to the 3GPP standard and may feedback the obtained bits to the base station 130. More specifically, steps 210 to 213 of FIG. 2 may comprise the base station 130 to transmit M CSI-RSs in different transmit directions, for example equally spaced within the sector identified by an initial access procedure in the communication cell 100, using specific beamformers. The UE 110 may measure the SINR for each received CSI-RS in order to obtain a measurement vector x of M real values. The UE 110 may select a subset of L CSI-RSs and report to the base station 130 the indices of these L CSI-RSs and a quantized and mapped version of their SINR values.

In step 214 of FIG. 2, the base station 130 may demap the received bits to reconstruct the SINR values.

The transmitting of CSI-RS signals to the UE 110 by the base station 130 and the following steps 211 to 214 may be repeated several times correspondingly by UEs 110 and correspondingly by the base station 130 as the UEs 110 move in the communication cell 100, for example over a fairly long period of time.

In steps 215 and 216 of FIG. 2 the base station 130 may compute statistics of the collected SINR values and may perform the quantization and mapping parameters design. The steps 215 and 216 may be performed once a long dataset of quantized CSI values has been collected and may conclude the training stage 210. Steps 215 and steps 216 may result in the base station 130 generating the one or more quantization codebooks for quantization and the one or more coding codebooks for mapping, which are cell-specific. Moreover, a quantizer implemented by the processing circuitry 131 of the base station 130, i.e., for generating the one or more quantization codebooks, may operate jointly on the L selected SINR values and the dictionary, i.e., the one or more coding codebooks, may provide the appropriate mapping for the jointly quantized values, with variable-length bit sequences for the various quantization values.

As will be appreciated, the training stage 210 may be repeated periodically and/or whenever needed due to changes in the cell propagation conditions of the communication cell 100.

In the exploitation stage 220, for each new UE 110 entering the communication cell 100, the base station 130 may communicate to the UE 110 the dictionary to be used for mapping, for example the one or more coding codebooks. Similarly, the base station 130 may provide the one or more quantization codebooks to the corresponding UE 110. Then the base station 130 may transmit CSI-RS signals to the UE 110.

In step 221 of FIG. 2, the UE 110 may perform the CSI estimation, e.g., in terms of SINR measurements or channel vectors.

In step 223 of FIG. 2, the UE 110 may perform the cell-specific quantization using the quantizer, i.e., based on the one or more quantization codebooks, possibly operating jointly and/or individually on the L SINR values, as defined in the step 215 of the training stage 210.

In step 225 of FIG. 2, the UE 110 may perform the cell-specific mapping of the quantized values into a bit sequence using the dictionary, for example the one or more coding codebooks, generated by the base station 130 at the end of the training stage, i.e., at step 216 of the training stage 210. The UE 110 may then transmit to the base station 130 the bit sequence.

In step 227 of FIG. 2, the base station 130 may perform the cell-specific demapping to obtain from the bit sequence the quantized values using the parameters, i.e., the one or more coding codebooks, established at the end of the training stage 210, i.e., at step 216 of the training stage 210.

In other words, in the training stage 210 the communication interface 133 of the base station 130 may be further configured to transmit one or more training pilot signals to the at least one UE 110 and to receive from the at least one UE 110 one or more quantized training CSI values. The processing circuitry 131 may be further configured to determine the one or more coding codebooks based on the one or more quantized training CSI values.

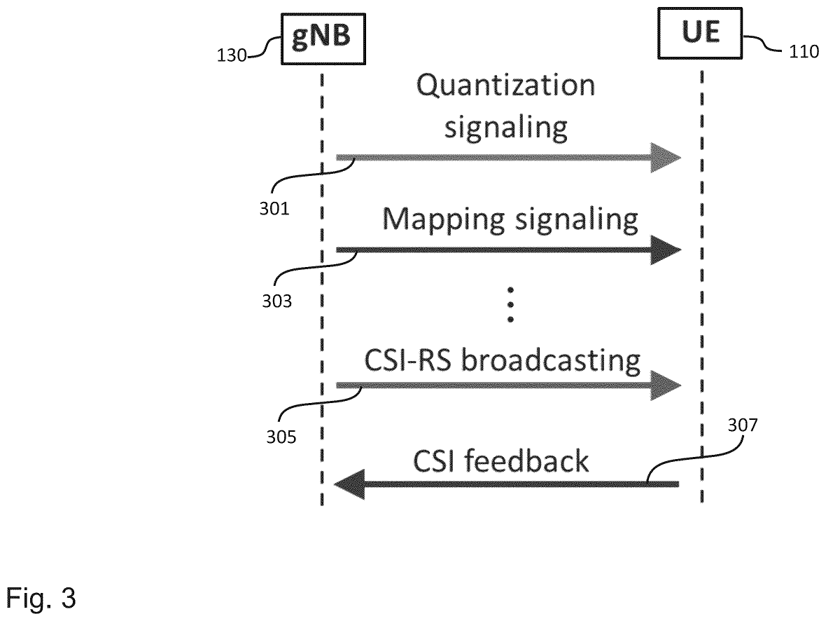

FIG. 3 is a schematic signaling diagram illustrating an additional control signaling phase for cell-specific quantization and mapping between the UE 110 and the base station 130 according to an embodiment of the present disclosure.

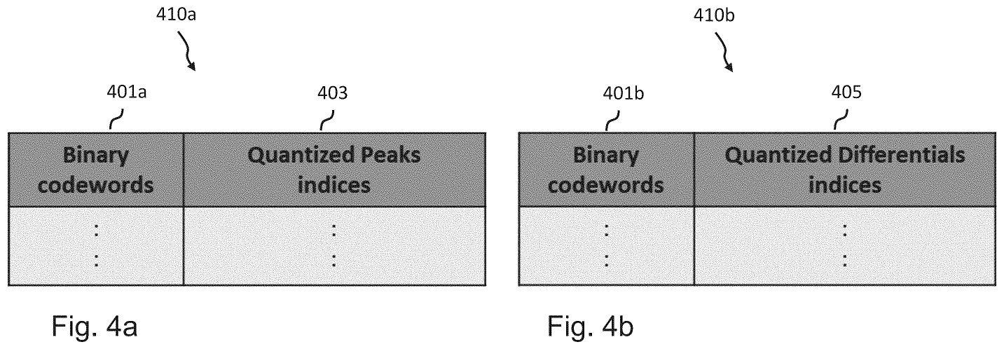

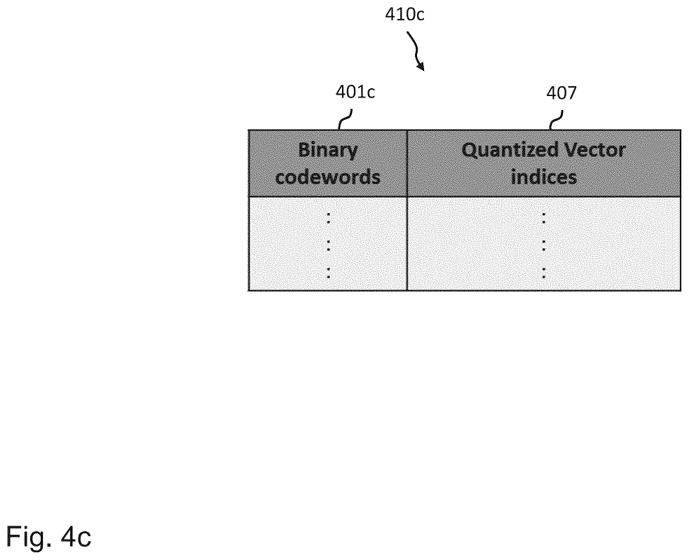

In step 301 of FIG. 3, the cell-specific quantization signaling may contain for example, as further described below in the embodiments of FIGS. 4a-c and 5a-c, the dictionary to be used by the UE 110 to quantize the vectors of SINRs.

In step 303 of FIG. 3, the cell-specific mapping signaling may contain, as further described below in the embodiments of FIGS. 4a-c and 5a-c, the dictionary mapping each index of quantized value into a variable-length sequence of bits.

In step 305 of FIG. 3, the base station 130 may perform CSI-RS broadcasting.

In step 307 of FIG. 3, the CSI feedback from the UE 110 may be based on a variable number of fed back bits, for example different to the 3GPP standard.

As will be appreciated, the implementation of the cell-specific quantization and/or mapping may require the base station 130 to communicate to the UE 110 the mapping dictionary, i.e., the bit sequences to be fed back in correspondence of each quantized value. The communication of the selected set of bit sequences may be done by providing either the set, explicitly, or the parameters to be used in a predefined model, e.g., a binary function giving as output the set. In an embodiment of the present disclosure, the communication of the selected set of bit sequences may be done by providing the index of the set from a predefined group of bit-sequence sets.

FIGS. 4a-b are schematic diagrams illustrating codebooks implemented by the UE 110 and the base station 130 according to an embodiment of the present disclosure for a Huffman coding.

In the training stage 210, the UEs 110 may report the M SINR measurements, quantized individually according to the method of 3GPP standard. The base station 130 may build two Huffman dictionaries 410a-b, one for the quantized peaks, i.e., a peaks dictionary 410a, and one for the collected differential measurements, i.e., a differential dictionary 410b, that comprise the specific mapping of each codeword based on the SINR measurements reported by all the UEs 110 involved in the training stage 210. According to the Huffman encoding scheme this may comprise that shorter bit sequences may be used for more frequently occurring codewords, and longer bit sequences may be used for less frequent codewords.

In the exploitation stage 220, the base station 130 may transmit M CSI-RS signals. The UE 110 may make SINR measurements on those M CSI-RS signals and may obtain a vector x. The UE 110 may quantize the SINR measurements individually according to the method of 3GPP standard and may obtain a vector x′. The UE 110 may transmit back to the base station 130: (i) the binary codeword 401a mapping to the peaks dictionary entry 403 corresponding to the quantized SINR peak and (ii) the L−1 binary codewords 401b mapping to the differential dictionary entries 405 corresponding to the L−1 differential SINRs. The base station 130, using the same Huffman dictionaries 410a-b, may then retrieve x′.

Here, the parameters to be transmitted to the UE 110 from the base station 130 in the additional control signaling phase shown in FIG. 3 are the two built Huffman dictionaries 410a-b. As will be appreciated, while the adopted quantization is implemented according to the 3GPP standard, i.e., it is not carried out jointly among the SINRs, the mapping scheme of FIGS. 4a-b is cell-specific and with variable-length bit sequences.

FIG. 4c is a schematic diagram illustrating a codebook implemented by the UE 110 and the base station 130 according to an embodiment of the present disclosure for a joint Huffman coding.

In the training stage 210, the UEs 110 may report the M SINR measurements, quantized individually according to the method of 3GPP standard. The base station 130 may build a single Huffman dictionary 410c and the specific mapping of each codeword, which represents a quantized vector of an M-dimensional vector space, without distinguishing between peak SINRs and differential SINR values.

In the exploitation stage 220, the base station 130 may transmit M CSI-RS signals. The UE 110 may make SINR measurements on those M CSI-RS signals and obtain a vector x. The UE 110 may quantize the SINR measurements individually according to the method of 3GPP standard and may obtain a vector x′. The UE 110 may transmit back to the base station 130 the binary codeword 401c mapping to the Huffman dictionary entry 407 corresponding to the quantized SINR vector x′. The base station 130, using the same codebook 410c, may retrieve x′.

Here, the parameter to be transmitted to the UE 110 from the base station 130 in the additional control signaling phase shown in FIG. 3 is the built joint Huffman dictionary 410c, that comprises the relative mapping bit sequences. Although quantization is still performed separately on each SINR, mapping is performed jointly on the whole set of quantized SINR values, thus achieving in part the advantages of a joint quantization. Moreover, the mapping is cell-specific.

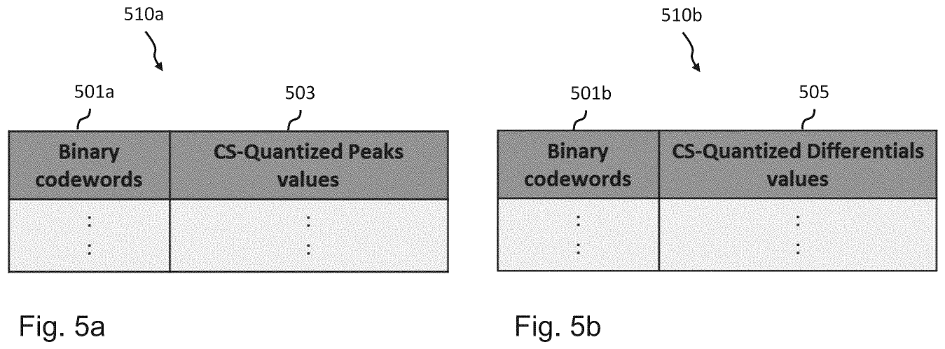

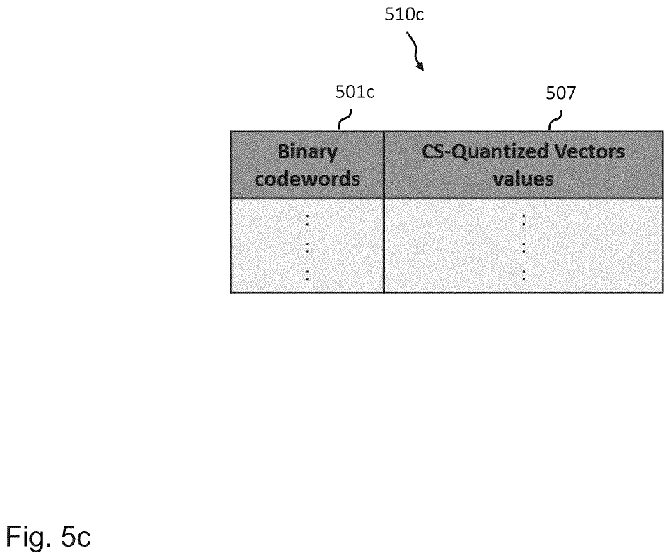

FIGS. 5a-b are schematic diagrams illustrating codebooks implemented by the UE 110 and the base station 130 according to an embodiment of the present disclosure for a cell-specific quantization and a Huffman coding.

In the training stage 210, the UEs 110 may report the M SINR measurements (non-quantized) to the base station 130. The base station 130 may build two cell-specific quantizers, both operating on scalars, one for the collected SINR peaks and one for the collected differential SINR measurements, i.e., as described above for steps 211 to 214 of FIG. 2, both with the same number of bits as in the 3GPP standard, that is 7 and 4, respectively. The parameters of the quantizers may be optimized according to the cell-specific SINR measurements. Two compressed Huffman dictionaries 510a-b, one for SINR peaks and one for differential SINR values comprising the relative mapping bit sequences may be built by the base station 130 starting from the cell-specific quantizers.

In the exploitation stage 220, the base station 130 may transmit M CSI-RS signals. The UE 110 may make SINR measurements on those M CSI-RS signals and may obtain a vector x of SINR values. The UE 110 may quantize the SINR measurements with the obtained cell-specific quantization codebooks and obtains vector x′. These codebooks may be designed according to the probability of observing specific peaks/differential SINR values in the communication cell 100. For example, clustering algorithms may provide a codebook of centroids, and the measured SINR values may be mapped to the centroids at minimum Euclidean distance. The UE 110 may transmit back to the base station 130: (i) the binary codeword 501a mapping to the peaks dictionary entry 503 corresponding to the quantized SINR peak and (ii) the L−1 binary codewords 501b mapping to the differential dictionary entries 505 corresponding to the L−1 differential SINRs. The base station 130, using the same mapping codebook, may retrieve x′.

Here, the parameters to be transmitted to the UE 110 in the additional control signaling phase shown in FIG. 3 are the two built Huffman dictionaries 510a-b. In this case both the quantization and the mapping are cell-specific, although no joint quantization is performed. As will be appreciated, the UE 110 (as well as other UEs within the communication cell) may further receive the corresponding quantization dictionaries.

FIG. 5c is a schematic diagram illustrating a codebook implemented by the UE 110 and the base station 130 according to an embodiment of the present disclosure for a joint quantization and a Huffman coding.

In the training stage 210, K≥2^{B}, where B is the number of quantization bits, UEs 110 may report the M SINR measurements (non-quantized) to the base station 130 by vectors x₁, x₂, . . . , x_{K}. The base station 130 may build a quantization codebook composed of 2^{B} vectors z₁, z₂, . . . , z₂_{^{B}}, each of length M. For example, vector quantization may be performed with the Linde-Buzo-Gray algorithm. In this case, codebook vectors z₁, z₂, . . . , z₂_{^{B}}_{LBG} may be the centroids (in mean-square-error sense) of 2^{B}^{_{LBG}} clusters obtained by clustering the M-sized training vectors x₁, x₂, . . . , x_{K}. The base station 130 may build a single Huffman dictionary 510c and the specific mapping of each codebook vector, which represents a quantized vector of an M-dimensional vector space, without distinguishing between peak SINRs and differential SINR values.

In the exploitation stage 220, the base station 130 may transmit M CSI-RS signals. The UE 110 may make SINR measurements on those M CSI-RS signals and obtain a vector x. The UE 110 may map said vector x to the quantization vector zᵢ that minimizes the Euclidean distance with respect to x, i.e., zᵢ=argmin_{z}∥x−z∥², z∈{z₁, z₂, . . . , z₂_{^{B}}_{LBG}}. The UE 110 may transmit back to the base station 130 the binary codeword 501c mapping to the Huffman dictionary entry 507 corresponding to the quantization vector zᵢ. The base station 130, using the same Huffman dictionary 510c, may retrieve zᵢ.

Here, the parameter to be transmitted to the UE 110 in the additional control signaling phase shown in FIG. 3 is the built Huffman dictionary 510c. This embodiment corresponds to a complete joint quantization and mapping with a cell-specific codebook and mapping dictionary. As will be appreciated, the UE 110 (as well as other UEs within the communication cell) may further receive the corresponding quantization dictionaries.

As already stated above, while embodiments above describe the quantization and mapping of the feedback SINR values, similar approaches can be adopted for other CSI data.

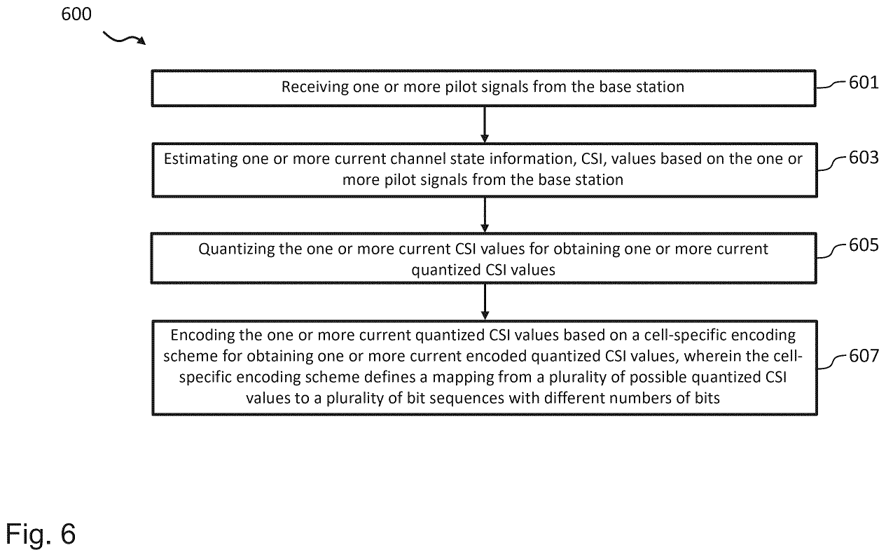

FIG. 6 shows a flow diagram illustrating a method 600 for operating the user equipment (UE) 110 for communication with the base station 130 according to an embodiment of the present disclosure.

The method 600 comprises a step 601 of receiving one or more pilot signals from the base station 130.

The method 600 further comprises a step 603 of estimating one or more current channel state information (CSI) values based on the one or more pilot signals from the base station 130.

The method 600 further comprises a step 605 of quantizing the one or more current CSI values for obtaining one or more current quantized CSI values.

The method 600 further comprises a step 607 of encoding the one or more current quantized CSI values based on a cell-specific encoding scheme for obtaining one or more current encoded quantized CSI values, wherein the cell-specific encoding scheme defines a mapping from a plurality of possible quantized CSI values to a plurality of bit sequences with different numbers of bits.

As the method 600 can be implemented by the UE 110, further features of the method 600 result directly from the functionality of the UE 110 and its different embodiments described above and below.

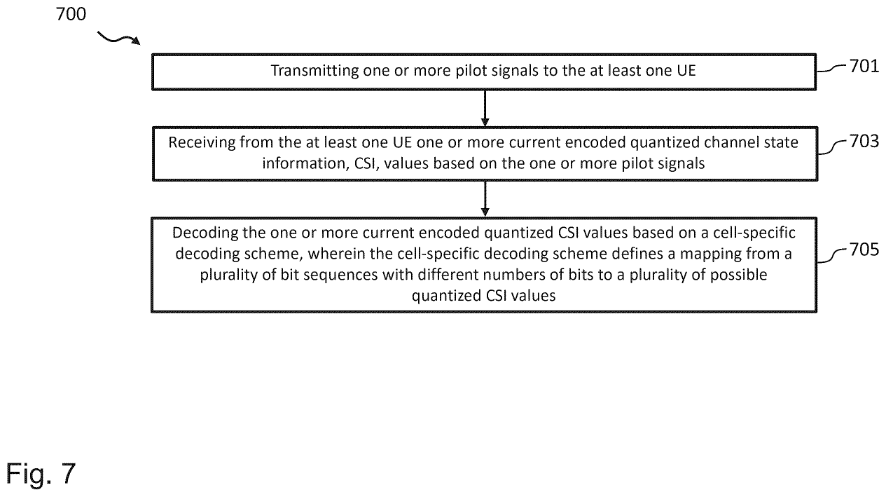

FIG. 7 shows a flow diagram illustrating a method 700 of operating the base station 130 for communication with the at least one user equipment (UE) 110 according to an embodiment of the present disclosure.

The method 700 comprises a step 701 of transmitting one or more pilot signals to the at least one UE 110.

The method 700 comprises a step 703 of receiving from the at least one UE 110 one or more current encoded quantized channel state information (CSI) values based on the one or more pilot signals.

The method 700 comprises a step 705 of decoding the one or more current encoded quantized CSI values based on a cell-specific decoding scheme, wherein the cell-specific decoding scheme defines a mapping from a plurality of bit sequences with different numbers of bits to a plurality of possible quantized CSI values.

As the method 700 can be implemented by the base station 130, further features of the method 700 result directly from the functionality of the base station 130 and its different embodiments described above and below.

The embodiments disclosed herein solve the technical problem by reducing the average amount of bits needed for the feedback by the UEs 110, without affecting the quality of the feedback, by introducing both a cell-specific solution and a more efficient mapping and a joint quantization.

In particular the joint quantization of the L selected SINRs allows to exploit possible correlations among the observed values that are recurring in the considered communication cell 100. This reduces the amount of feedback needed without sacrificing the accuracy.

Moreover, the use of a cell-specific quantization codebook exploits the peculiar propagation conditions of each cell, using more quantization values in correspondence of most frequent SINR values. This provides a more accurate CSI feedback without increasing the overhead.

Moreover, the use of a cell-specific mapping with variable-length bit sequences to represent (and feedback) the quantized values leverages the different statistics of the quantized values (still related to the cell propagation conditions) and reduces the amount of feedback without sacrificing the accuracy.

The person skilled in the art will understand that the “blocks” (“units”) of the various figures (method and apparatus) represent or describe functionalities of embodiments of the present disclosure (rather than necessarily individual “units” in hardware or software) and thus describe equally functions or features of apparatus embodiments as well as method embodiments (unit=step).

In the several embodiments provided in the present application, it should be understood that the disclosed system, apparatus, and method may be implemented in other manners. For example, the described embodiment of an apparatus is merely exemplary. For example, the unit division is merely logical function division and may be another division in an actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of the invention may be integrated into one processing unit, or each of the units may exist alone physically, or two or more units may be integrated into one unit.

What is claimed is:

1. A user equipment (UE) for communication with a base station, wherein the UE comprises:
a communication interface configured to receive one or more pilot signals from the base station; and
a processing circuitry configured to:
estimate one or more current channel state information (CSI) values based on the one or more pilot signals from the base station;
quantize the one or more current CSI values for obtaining one or more current quantized CSI values; and
encode the one or more current quantized CSI values based on a cell-specific encoding scheme for obtaining one or more current encoded quantized CSI values, wherein the cell-specific encoding scheme defines a mapping from a plurality of possible quantized CSI values to a plurality of bit sequences with different numbers of bits.

2. The UE of claim 1, wherein the communication interface is further configured to transmit the one or more current encoded quantized CSI values to the base station.

3. The UE of claim 1, wherein the mapping defined by the cell-specific encoding scheme is configured to map the plurality of possible quantized CSI values to the plurality of bit sequences with different numbers of bits depending on a respective occurrence frequency of each of the plurality of possible quantized CSI values.

4. The UE of claim 3, wherein the mapping defined by the cell-specific encoding scheme is configured to map the most frequent possible quantized CSI values of the plurality of possible quantized CSI values to bit sequences of the plurality of bit sequences having a smallest numbers of bits.

5. The UE of claim 1, wherein the cell-specific encoding scheme is defined by one or more coding codebooks.

6. The UE of claim 5, wherein the communication interface is further configured to receive from the base station the one or more coding codebooks and/or information allowing the processing circuitry to generate or retrieve the one or more coding codebooks.

7. The UE of claim 1, wherein the communication interface is further configured to receive one or more quantization codebooks from the base station and/or information allowing the processing circuitry to generate or retrieve the one or more quantization codebooks, and wherein the processing circuitry is further configured to quantize the one or more current CSI values for obtaining the one or more current quantized CSI values based on the one or more quantization codebooks.

8. The UE of claim 7, wherein the one or more current CSI values comprise a plurality of current signal to interference plus noise ratio (SINR) values and wherein the one or more quantization codebooks comprise a first quantization codebook for quantizing a peak value of the plurality of current SINR values and a second quantization codebook for quantizing one or more differential values of the plurality of current SINR values relative to the peak value.

9. The UE of claim 1, wherein the one or more current CSI values comprise a plurality of current CSI values, and wherein the processing circuitry is further configured to quantize the plurality of current CSI values using a vector quantization scheme.

10. A method for operating a user equipment (UE) for communication with a base station, wherein the method comprises:
receiving one or more pilot signals from the base station;
estimating one or more current channel state information (CSI) values based on the one or more pilot signals from the base station;
quantizing the one or more current CSI values for obtaining one or more current quantized CSI values; and
encoding the one or more current quantized CSI values based on a cell-specific encoding scheme for obtaining one or more current encoded quantized CSI values, wherein the cell-specific encoding scheme defines a mapping from a plurality of possible quantized CSI values to a plurality of bit sequences with different numbers of bits.

11. A base station for communication with at least one user equipment (UE), wherein the base station comprises:
a communication interface configured to transmit one or more pilot signals to the at least one UE and to receive from the at least one UE one or more current encoded quantized channel state information (CSI) values based on the one or more pilot signals; and
a processing circuitry configured to decode the one or more current encoded quantized CSI values based on a cell-specific decoding scheme, wherein the cell-specific decoding scheme defines a mapping from a plurality of bit sequences with different numbers of bits to a plurality of possible quantized CSI values.

12. The base station of claim 11, wherein the mapping defined by the cell-specific decoding scheme is configured to map the plurality of bit sequences with different numbers of bits to the plurality of possible quantized CSI values depending on a respective occurrence frequency of each of the plurality of possible quantized CSI values.

13. The base station of claim 12, wherein the mapping defined by the cell-specific decoding scheme is configured to map the bit sequences of the plurality of bit sequences having a smallest numbers of bits to the most frequent possible quantized CSI values of the plurality of possible quantized CSI values.

14. The base station of claim 11, wherein the cell-specific decoding scheme is defined by one or more coding codebooks.

15. The base station of claim 14, wherein the communication interface is further configured to transmit to the at least one UE the one or more coding codebooks and/or information allowing a processing circuitry of the at least one UE to generate or retrieve the one or more coding codebooks.

16. The base station of claim 14, wherein in a training stage the communication interface is further configured to transmit one or more training pilot signals to the at least one UE and to receive from the at least one UE one or more quantized training CSI values and wherein the processing circuitry is further configured to determine the one or more coding codebooks based on the one or more quantized training CSI values.

17. The base station of claim 11, wherein the communication interface is further configured to transmit to the at least one UE one or more quantization codebooks and/or information allowing a processing circuitry of the at least one UE to generate or retrieve the one or more quantization codebooks, wherein the one or more quantization codebooks allow the processing circuitry of the at least one UE to generate the one or more current encoded quantized CSI values.

18. The base station of claim 17, wherein the one or more quantization codebooks define a vector quantization.
